(19) United States
(12) Patent Application Publication
(10) Pub. No.: US 2025/0180140 A1
(43) Pub. Date: Jun. 5, 2025

(54) MONITORING SPRING RETURN ACTUATORS

(71) Applicant: Saudi Arabian Oil Company, Dhahran (SA)

(72) Inventor: Lahdan Fahad Al Faihan, Dhahran (SA)

(21) Appl. No.: 19/044,118

(22) Filed: Feb. 3, 2025

Related U.S. Application Data
(62) Division of application No. 17/308,733, filed on May 5, 2021.

(51) Int. Cl. F16K 37/00; F15B 19/00

(52) U.S. Cl. CPC F16K 37/0083; F15B 19/002; F16K 37/0041; F15B 19/005; F15B 2211/6306; F15B 2211/857

(57) ABSTRACT

A spring return hydraulic or pneumatic valve is actuated, by an actuator, from a first position to a second position. A displacement of the valve is measured. A hydraulic or pneumatic pressure of the valve actuator is measured. A spring constant of the spring is calculated based on the measured displacement and the measured pressure. The calculated spring constant is compared with a manufacturer listed spring constant.

### TECHNICAL FIELD

This disclosure relates to actuated valves with spring returns.

### BACKGROUND

Hydraulically and pneumatically actuated control valves are widespread throughout a variety of industries. In general, such valves are configured to “fail” (that is, return to a default position when pneumatic or hydraulic pressure is removed) into a closed state or an open state with a bias, such as a spring. Such valves can be based upon a piston and cylinder arrangement (piston style), a diaphragm arrangement (diaphragm style), or another arrangement. Regardless of the arrangement, the actuator includes a pressure chamber defined, in part, by a movable or deformable portion of the chamber. The movable or deformable portion of the chamber displaces or deforms in response to a pressure build-up in the chamber increasing to overcome the bias, which generally abuts the movable or deformable portion of the pressure chamber.

### SUMMARY

This specification describes technologies relating to monitoring spring return actuators.

An example implementation of the subject matter within this disclosure is a method with the following features. A spring return hydraulic or pneumatic valve is actuated, by an actuator, from a first position to a second position. A displacement of the valve is measured. A hydraulic or pneumatic pressure of the valve actuator is measured. A spring constant of the spring is calculated based on the measured displacement and the measured pressure. The calculated spring constant is compared with a manufacturer listed spring constant.

Aspects of the example method, which can be combined with the example method alone or in combination with other aspects, include the following. The calculated spring constant is determined to be less than the listed spring constant by a specified threshold. The spring is replaced responsive to determining the spring constant is less than the listed spring constant by the specified threshold.

Aspects of the example method, which can be combined with the example method alone or in combination with other aspects, include the following. The specified threshold is 10%.

Aspects of the example method, which can be combined with the example method alone or in combination with other aspects, include the following. The calculated spring constant is determined to be greater than the listed spring constant by a specified threshold. A valve packing is loosened responsive to determining that the calculated spring constant is greater than the listed spring constant by the specified threshold.

Aspects of the example method, which can be combined with the example method alone or in combination with other aspects, include the following. The specified threshold is 10%.

Aspects of the example method, which can be combined with the example method alone or in combination with other aspects, include the following. The first position is a default, depressurized position of the valve.

Aspects of the example method, which can be combined with the example method alone or in combination with other aspects, include the following. The second position is a full stroke of the valve.

Aspects of the example method, which can be combined with the example method alone or in combination with other aspects, include the following. The second position is a partial stroke of the valve.

An example implementation of the subject matter described within this disclosure is a hydraulic or pneumatic valve system with the following features. An actuator includes a displacement surface arranged to receive a pressurized fluid on a first side. A spring is coupled to the displacement surface. The spring is biased against the pressurized fluid. The displacement surface is configured to displace responsive to the pressurized fluid and the spring. A displacement sensor is configured to measure a displacement of the displacement surface. The display sensor is configured to produce a displacement stream representative of the displacement of the displacement surface. A pressure sensor is located on a pressurized side of the displacement surface. The pressure sensor is configured to measure a pressure of the pressurized fluid. The pressure sensor is configured to produce a pressure stream representative of the pressure of the pressurized fluid. A controller is configured to receive the displacement stream. The controller is configured to receive the pressure stream. The controller is configured to determine a calculated spring constant of a valve spring based on the received displacement stream and the received pressure stream. The controller is configured to compare the calculated spring constant with a specified spring constant.

Aspects of the example hydraulic or pneumatic valve system, which can be combined with the example hydraulic or pneumatic valve system alone or in combination with other aspects, include the following. The displacement sensor is an optical sensor.

Aspects of the example hydraulic or pneumatic valve system, which can be combined with the example hydraulic or pneumatic valve system alone or in combination with other aspects, include the following. The displacement sensor is a magnetic sensor.

Aspects of the example hydraulic or pneumatic valve system, which can be combined with the example hydraulic or pneumatic valve system alone or in combination with other aspects, include the following. The displacement sensor includes a LIDAR sender and receiver.

Aspects of the example hydraulic or pneumatic valve system, which can be combined with the example hydraulic or pneumatic valve system alone or in combination with other aspects, include the following. The controller is further configured to determine that the calculated spring constant is less than the specified spring constant by a specified threshold. The controller is further configured to create a notification to replace the valve spring responsive to determining that the calculated spring constant is less than the specified spring constant by a specified threshold.

Aspects of the example hydraulic or pneumatic valve system, which can be combined with the example hydraulic or pneumatic valve system alone or in combination with other aspects, include the following. The controller is further configured to determine that the calculated spring constant is greater than the specified spring constant by a specified threshold. The controller is configured to create a notification to loosen the valve packing responsive to determining that the calculated spring constant is greater than the specified spring constant by a specified threshold.

An example implementation of the subject matter described within this disclosure is a method with the following features. A pneumatic or hydraulic valve is actuated, by an actuator, from a first position to a second position. A displacement of the valve between the first position and the second position is measured. A pneumatic or hydraulic pressure of the valve actuator is measured after actuating the pneumatic or hydraulic valve. A spring constant of the spring is calculated based on the measured displacement and the measured pressure. The calculated spring constant is compared with a manufacturer listed spring constant. The calculated spring constant is determined to be less than the listed spring constant by a specified threshold. The spring is replaced responsive to determining that the calculated spring constant is less than the listed spring constant by a specified threshold.

Aspects of the example method, which can be combined with the example method alone or in combination with other aspects, include the following. The specified threshold is 10%.

Aspects of the example method, which can be combined with the example method alone or in combination with other aspects, include the following. The first position is a fully closed position of the valve.

Aspects of the example method, which can be combined with the example method alone or in combination with other aspects, include the following. The first position is a fully open position of the valve.

Aspects of the example method, which can be combined with the example method alone or in combination with other aspects, include the following. The second position is a full stroke of the valve.

Aspects of the example method, which can be combined with the example method alone or in combination with other aspects, include the following. The second position is a partial stroke of the valve.

Particular embodiments of the subject matter described in this specification can be implemented so as to realize one or more of the following advantages. Aspects described within this disclosure provide early detection and monitoring of control valve health. The data obtained and the resulting improved maintenance can improve control valve position and lead to more accurate process control when compared to unmonitored systems.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1C are side cross-sectional views of example piston-style, spring return actuators.

FIGS. 2A-2C are side cross-sectional views of example diaphragm-style, spring return actuators.

FIG. 3 is a block diagram of an example controller that can be used with aspects of this disclosure.

FIG. 4 is a flowchart of an example method that can be used with aspects of this disclosure.

Like reference numbers and designations in the various drawings indicate like elements.

### DETAILED DESCRIPTION

Springs within control valves can be cycled frequently depending upon their role in a process. Alternatively or in addition, such springs can be exposed to the elements, resulting in corrosion damage. Such environments can include offshore operations or in areas with prevalent sour gas production. Regardless of the cause, the return springs in control valves wear and fail overtime. As the spring return is necessary for valve actuator operations, such a failure can cause significant operational disruptions, especially if such a failure occurs unexpectedly.

This disclosure relates to determining the health of a spring within a control valve. The control valve includes a position sensor and a pressure sensor to determine a valve position as a function of pressure on the valve actuator. Using this information, in combination with detailed valve specifications, a health of the spring can be determined. In some implementations, other health benefits of the valve can be determined, for example, a state of the valve packing.

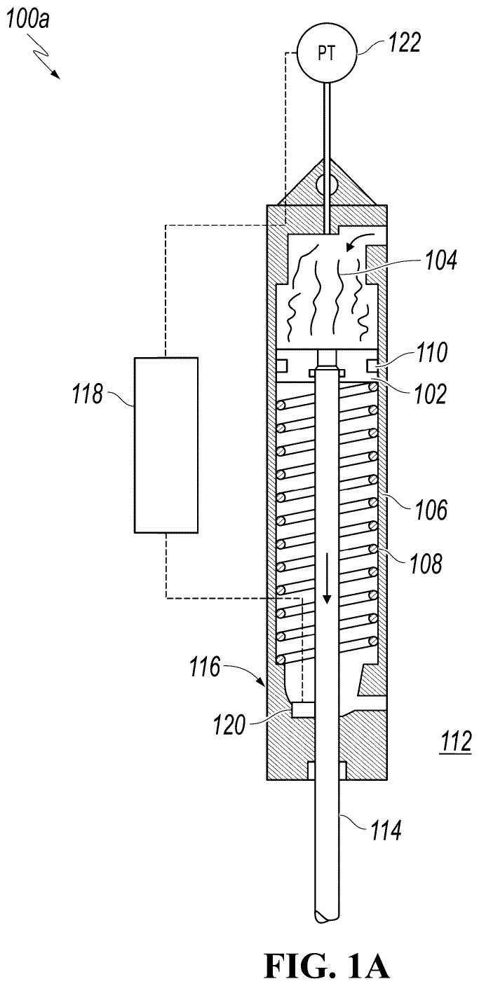

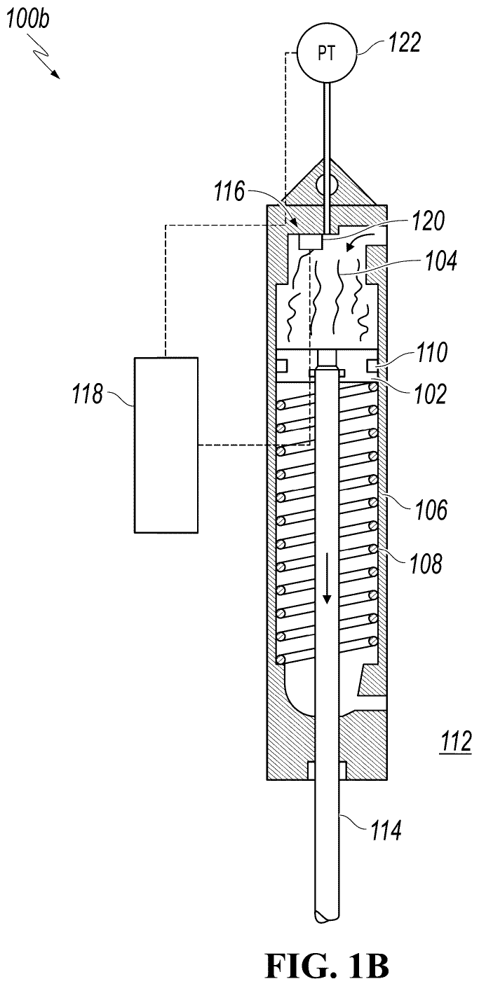

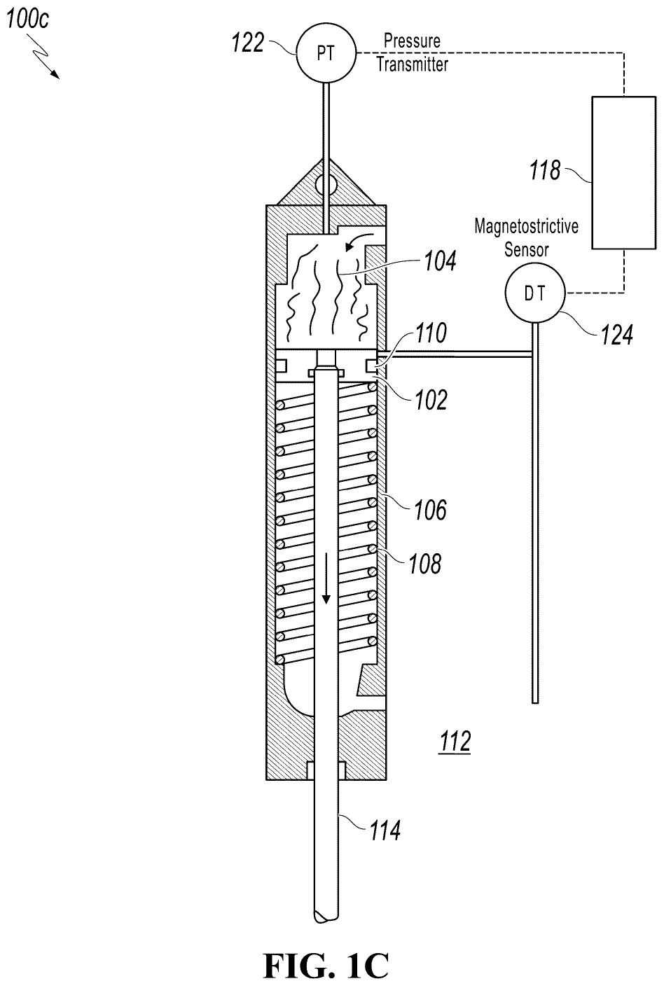

FIGS. 1A-1C are side cross-sectional views of example piston-style, spring return actuators 100a, 100b, and 100c. Referring to FIG. 1A, the actuator 100a includes a displacement surface, in this case, a piston 102. The piston 102 defines a portion of the pressure chamber 104 which is further defined by the cylinder (housing) 106. The piston itself has a profile slightly less than that of the inner wall of the housing 106 as to allow free movement of the piston 102 to reduce the risk of binding to the housing. In some implementations, a lubricant, such as grease, can be used to further reduce such a risk of binding. The piston 102 is configured to move (that is, linearly displace) such that a balance of forces between a bias, in this case, a compression spring 108, and the pressure chamber 104 are balanced. In some implementations, the piston 102 can include a seal, such as an elastomeric O-ring 110, to seal (that is, partially or completely seal) the pressure chamber from an outside environment. Such an elastomeric O-ring 110 can result in an interference fit between the piston 102 and the housing 106. In such an instance, the elastomeric O-ring deforms to both provide an adequate seal and to allow freedom of motion of the piston 102.

As mentioned, the compression spring 108 is coupled to the piston 102. The compression spring 108 is biased against the pressurized fluid within the pressure chamber 104. Generally, the compression spring is retained within the housing opposite the piston at a first end of the compression spring 108, and the compression spring abuts the piston 102 at a second end of the compression spring 108. In some implementations, the spring can extend beyond the housing 106. The housing 106 containing the spring often has a vent that allows the pressure within the spring housing to maintain a same (or similar) pressure with an outside environment 112. While primarily illustrated and described as include a compression spring 108, the actuator 100a can include other bias mechanisms, such as a tension spring or an air spring, without departing from this disclosure. While primarily illustrated and described as being on a side of the piston 102 opposite of the pressure chamber 104, in some implementations, the compression spring 108 can be on a same side of the piston 102 as the pressure chamber 104, for example, when a tension spring is used.

Connected to the piston 102 is a valve shaft 114. The valve shaft 114 is coupled to and configured to move in unison with, the piston 102. The valve shaft 114 is coupled to linkages (not shown) of a valve to adjust a flow area within the valve. For example, in a gate valve, the valve shaft 114 can be directly coupled to the gate to move the gate between and open and a closed position. In some implementations, additional linkage components can be used depending upon the configuration of the valve. For example, the piston 102 can be attached a rotary-type valve, and can include linkage components to translate the linear motion of the piston 102 into rotary motion. For example, a rack and pinion arrangement can be used in such a use case.

A displacement sensor 116 is configured to measure a displacement of the piston 102. The displacement sensor 116 is configured to produce a displacement stream representative of the displacement of the piston. The displacement stream can include a digital or analog signal that can be interpreted by a controller 118. Details on the controller 118 are described throughout this disclosure. The displacement sensor 116 itself can include a variety of different technologies, such as a light Detection and Ranging (LIDAR) system, radar systems, optical systems, electromagnetic systems, or other displacement sensing systems. Examples of such systems are described throughout this disclosure, but it should be recognized that other displacement measurement systems can be used without departing from this disclosure. The implementation illustrated in FIG. 1A includes a LIDAR emitter and sensor 120 within the spring chamber. The LIDAR emitter and sensor 120 is located at an end of the spring chamber opposite of the piston 102. The LIDAR emitter and sensor 120 works by emitting a light beam towards the piston 102, and measuring the time it takes for the light beam to return to the LIDAR emitter and sensor 120. While primarily described as using LIDAR, radar or sonic technologies can be similarly used without departing from this disclosure. In some implementations, regardless of the displacement sensor 116 used, the displacement sensor 116 can be ruggedized for permanent installation on the valve actuator. Such ruggedization can include material selection, shielding, or both, applied to the displacement sensor 116 to ensure a long, reliable life, for example, several years.

A pressure sensor is located on a pressurized side (that is, the side of the piston that receives pressurized fluid) of the piston 102. The pressure sensor is configured to measure a pressure of the pressurized fluid within the pressure chamber 104. The pressure sensor 122 is configured to produce a pressure stream representative of the pressure of the pressurized fluid. The pressure stream can include a digital or analog signal that can be interpreted by the controller 118. The pressure sensor can include a transducer, piezoelectric device, or any other pressure sensor. In some implementations, regardless of the pressure sensor 122 used, the pressure sensor 122 can be ruggedized for permanent installation on the valve actuator. Such ruggedization can include material selection, shielding, or both, applied to the pressure sensor 122 to ensure a long, reliable life, for example, several years.

FIG. 1B illustrates actuator 100b. Actuator 100b is substantially similar to actuator 100a with the exception of any differences described herein. The LIDAR emitter and receiver is located within the pressure chamber 104. The LIDAR emitter and sensor 120 operates at a wavelength that is not overly attenuated by the hydraulic or pneumatic fluid as to cause spurious or noisy readings.

FIG. 1C illustrates actuator 100c. Actuator 100c is substantially similar to actuator 100a with the exception of any differences described herein. Actuator 100c uses a magnetostrictive sensor 124 to detect the position of the piston 102 through the housing 106. While primarily described as a magnetostrictive sensor 124, other electromagnetic sensors can be used without departing from this disclosure.

Other position sensor can be used without departing from this disclosure, for example, an optical sensor, such as an encoder, can be used without departing from this disclosure.

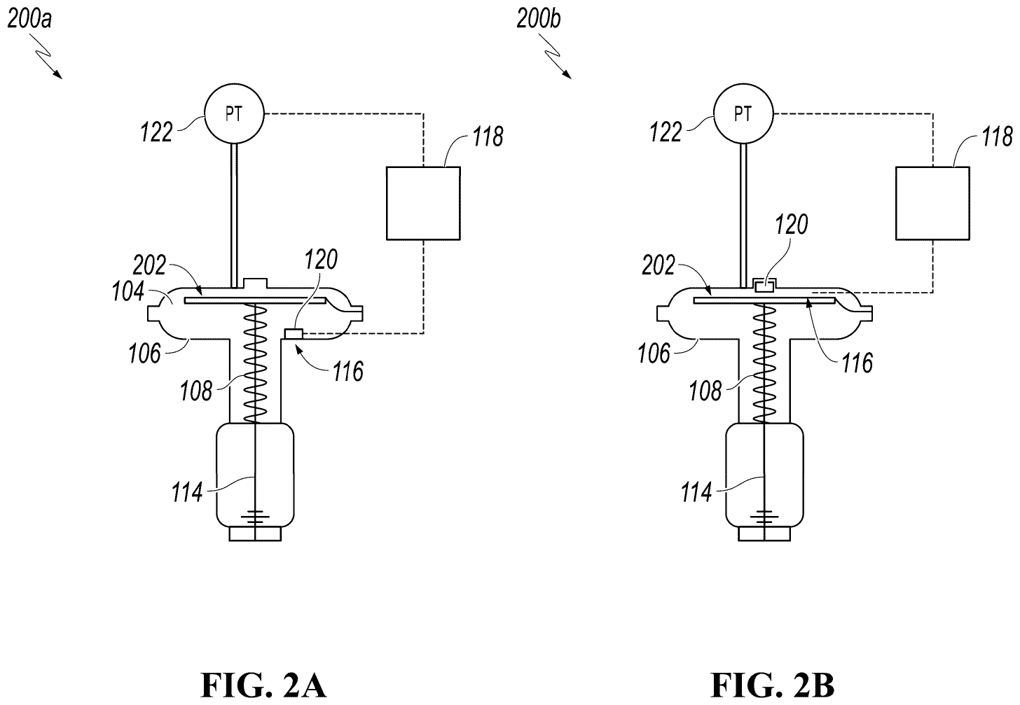

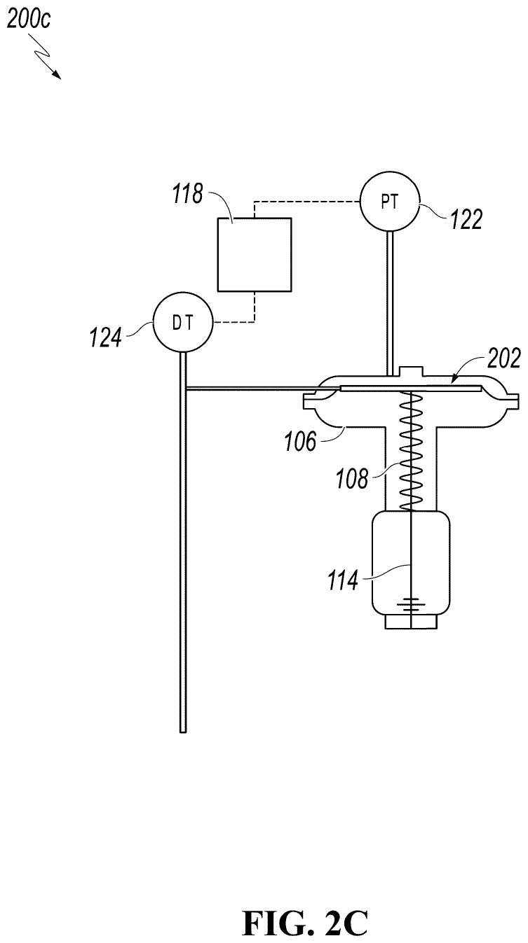

FIGS. 2A-2C are side cross-sectional views of example diaphragm-style, spring return actuators 200a, 200b, and 200c. Referring to FIG. 2A, the diaphragm actuator 200a is substantially similar to actuator 100a with the exception of any differences described herein. The actuator 200a includes a displacement surface, in this case, a diaphragm 202. The diaphragm 202 defines a portion of the pressure chamber 104 which is further defined by a housing 106. The diaphragm 202 is configured to deform (that is, a center of the diaphragm linearly displaces) such that a balance of forces between a bias, in this case, a compression spring 108, and the pressure chamber 104 are balanced. In some implementations, the diaphragm acts as a seal in order to seal (that is, partially or completely seal) the pressure chamber from an outside environment. The diaphragm itself can include an elastomeric material across all or part of the diaphragm 202. For example, a metallic plate surrounded by a flexible elastomeric membrane extending from an edge of the metallic plate can be used as the diaphragm 202. Alternatively, the diaphragm 202 can be made entirely of an elastomeric material. The diaphragm 202 is held in place by the housing 106, for example with two housing halves compressed together in order to retain the diaphragm 202.

As mentioned, the compression spring 108 is coupled to the diaphragm 202. The compression spring 108 is biased against the pressurized fluid within the pressure chamber 104 at a first end of the compression spring 108, and the compression spring abuts the diaphragm at a second end of the compression spring 108. Generally, the compression spring is retained within the housing 106. While primarily illustrated and described as including a compression spring 108, the actuator 200a can include other bias mechanisms, such as a tension spring or an air spring, without departing from this disclosure. While primarily illustrated and described as being on a side of the diaphragm 202 opposite of the pressure chamber 104, in some implementations, the compression spring 108 can be on a same side of the diaphragm 202 as the pressure chamber 104, for example, when a tension spring is used.

Connected to the diaphragm 202 is the valve shaft 114. The valve shaft 114 is coupled to, and configured to move in unison with, the piston 102. The valve shaft 114 is coupled to linkages (not shown) of a valve to adjust a flow area within the valve. For example, in a gate valve, the valve shaft 114 can be directly coupled to the gate to move the gate between and open and a closed position. In some implementations, similar to the situations previously described, additional linkage components can be used depending upon the configuration of the valve.

The implementation illustrated in FIG. 2A includes a LIDAR emitter and sensor 120 within the spring chamber. The LIDAR emitter and sensor 120 is located at an end of the housing 106 opposite of the diaphragm 202.

FIG. 2B illustrates actuator 200b. Actuator 200b is substantially similar to actuator 200a with the exception of any differences described herein. The LIDAR emitter and receiver is located within the pressure chamber 104. The LIDAR emitter and sensor 120 operates at a wavelength that is not overly attenuated by the hydraulic or pneumatic fluid as to cause spurious or noisy readings.

FIG. 2C illustrates actuator 200c. Actuator 200c is substantially similar to actuator 200a with the exception of any differences described herein. Actuator 200c uses a magnetostrictive sensor 124 to detect the position of the diaphragm 202 through the housing 106. While primarily described as a magnetostrictive sensor 124, other electromagnetic sensors can be used without departing from this disclosure.

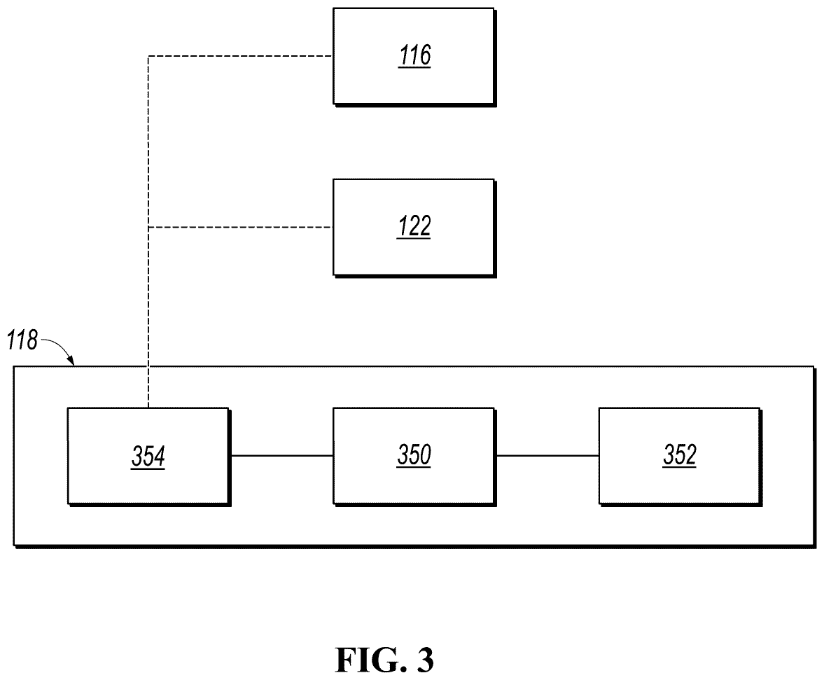

FIG. 3 is a block diagram of an example controller 118 that can be used with aspects of this disclosure. The controller 118 can, among other things, monitor parameters of the system, send signals to actuate or adjust various operating parameters of the system, or both. As shown in FIG. 3, the controller 118, in certain instances, includes a processor 350 (e.g., implemented as one processor or multiple processors) and a memory 352 (e.g., implemented as one memory or multiple memories) containing instructions that cause the processors 350 to perform operations described herein. The processors 350 are coupled to an input/output (I/O) interface 354 for sending and receiving communications with components in the system, including, for example, the sensors 116, 122, or both. In certain instances, the controller 118 can additionally communicate status with and send actuation and/or control signals to one or more of the various system components (including a pressure chamber 104) of a control valve as well as other sensors (e.g., pressure sensor 122, displacement sensor 116, and other types of sensors) provided with the valve. In certain instances, the controller 118 can communicate status and send actuation and control signals to one or more of the components within the valve, such as an actuator (100a-100c, 200a-200c). The communications can be hard-wired, wireless, or a combination of wired and wireless. In some implementations, controllers similar to the controller 118 can be located elsewhere, such as in a control room, elsewhere on a site, or even remote from the site. In some implementations, the controller 118 can be a distributed controller with different portions located about a site or off site. For example, in certain instances, the controller 118 can be located at the valve, or it can be located in a separate control room or data van. Additional controllers can be used throughout the site as stand-alone controllers or networked controllers without departing from this disclosure. Input and output signals, including the data from the sensor, controlled and monitored by the controller 118, can be logged continuously by the controller 118.

The controller 118 can have varying levels of autonomy for controlling and monitoring a control valve. For example, the controller 118 can detect and display data from the pressure stream, the displacement stream, or both, and an operator can interpret the streams to determine a health of the valve. Alternatively, the controller 118 can detect and display data from the pressure stream, the displacement stream, or both, and can alert an operator to the health condition of the valve. Alternatively, the controller 118 can detect and display data from the pressure stream, the displacement stream, or both, and can initiate a work order or other work flow to have the valve repaired.

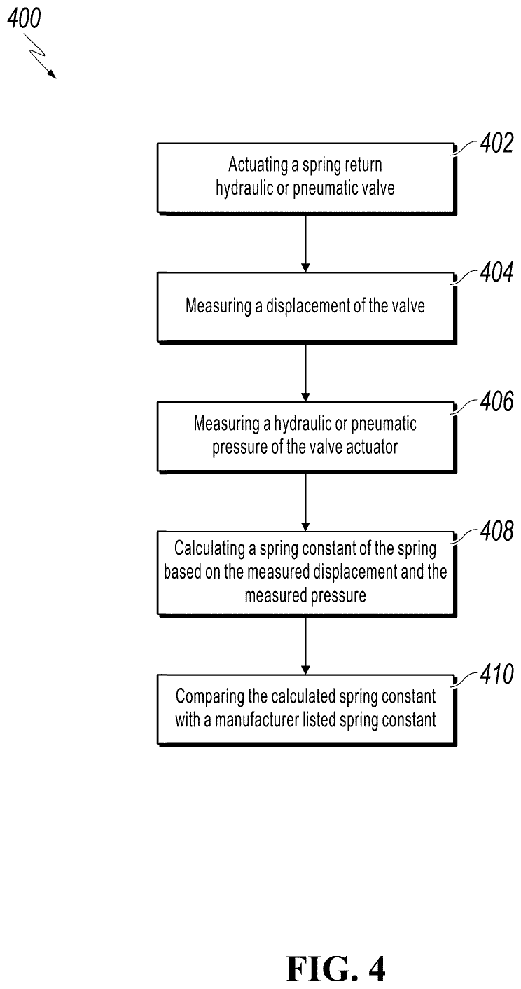

FIG. 4 is a flowchart of an example method 400 that can be used with aspects of this disclosure. In some implementations, parts of method 400 can be partially or entirely performed by the controller 118. At 402, a spring return hydraulic or pneumatic valve is actuated, by an actuator, from a first position to a second position. In some implementations, the first position is a default, depressurized position of the valve. In some implementations, the second position is a full stroke of the valve. For example, the first position of the valve is a fully open position, and the second position of the valve is a fully closed position, or vice versa. In some implementations, the second position is a partial stroke of the valve. For example the first position of the valve is a fully open position, and the second position is a partially closed position. Such actuations can be performed during normal operations, or in instances where fully closing the valve is not feasible. Such operations can also be used on throttling valves, for example, globe valves, as operations do not always permit such valves to be fully open or fully closed.

At 404, a displacement of the valve is measured. Such measurements can be taken by position or displacement sensors, such as any of the position or displacement sensors described throughout this disclosure. In some implementations, the position or displacement sensor produces a displacement stream that is interpretable by a controller, such as the controller 118.

At 406, a hydraulic or pneumatic pressure of the valve actuator is measured. Such measurements can be taken by a pressure sensor, such as any of the pressure sensors described throughout this disclosure. In some implementations, the pressure sensor produces a pressure stream that is interpretable by a controller, such as the controller 118. At 408, a spring constant of the spring is calculated based on the measured displacement and the measured pressure. Such a determination can be made as the surface area of the displacement surface is known from specifications provided by the manufacture. Such information combined with the measured pressure and displacement can be used to determine the calculated spring constant. At 410, the calculated spring constant is compared with a manufacturer listed spring constant.

In some instances, it is determined (for example, by the controller), that the calculated spring constant is less than the listed spring constant by a specified threshold, for example, by 10% or more. Such a determination is indicative of a worn spring, for example, from fatigue or corrosion. In such instances, the spring can be replaced responsive to determining the spring constant is less than the listed spring constant by the specified threshold.

In some instances, it is determined, (for example, by the controller), that the calculated spring constant is greater than the listed spring constant by a specified threshold. Such a result can be caused by numerous factors, for example, packing of the valve being too tight. As such, the valve packing may be loosened responsive to determining that the calculated spring constant is greater than the listed spring constant by the specified threshold, for example, by 10% or more. Alternatively or in addition, depending on the type of valve, other actions can be taken, such as lubricating the actuator.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A method comprising:
actuating a spring return hydraulic or pneumatic valve, by an actuator, from a first position to a second position;
measuring a displacement of the valve;
measuring a hydraulic or pneumatic pressure of the valve actuator;
calculating a spring constant of the spring based on the measured displacement and the measured pressure; and
comparing the calculated spring constant with a manufacturer listed spring constant.

2. The method of claim 1, further comprising;
determining that the calculated spring constant is less than the listed spring constant by a specified threshold; and
replacing the spring responsive to determining the spring constant is less than the listed spring constant by the specified threshold.

3. The method of claim 2, wherein the specified threshold is 10%.

4. The method of claim 1, further comprising:
determining that the calculated spring constant is greater than the listed spring constant by a specified threshold; and
loosening a valve packing responsive to determining that the calculated spring constant is greater than the listed spring constant by the specified threshold.

5. The method of claim 4, wherein the specified threshold is 10%.

6. The method of claim 1, wherein the first position is a default, depressurized position of the valve.

7. The method of claim 1, wherein the second position is a full stroke of the valve.

8. The method of claim 1, wherein the second position is a partial stroke of the valve.

9. A hydraulic or pneumatic valve system comprising:
an actuator comprising:
a displacement surface arranged to receive a pressurized fluid on a first side;
a spring coupled to the displacement surface, the spring being biased against the pressurized fluid, the displacement surface configured to displace responsive to the pressurized fluid and the spring;
a displacement sensor configured to measure a displacement of the displacement surface, the display sensor configured to produce a displacement stream representative of the displacement of the displacement surface;
a pressure sensor located on a pressurized side of the displacement surface, the pressure sensor configured to measure a pressure of the pressurized fluid, the pressure sensor configured to produce a pressure stream representative of the pressure of the pressurized fluid; and
a controller configured to:
receive the displacement stream;
receive the pressure stream;
determine a calculated spring constant of a valve spring based on the received displacement stream and the received pressure stream; and
compare the calculated spring constant with a specified spring constant.

10. The hydraulic or pneumatic valve of claim 9, wherein the displacement sensor is an optical sensor.

11. The hydraulic or pneumatic valve of claim 9, wherein the displacement sensor is a magnetic sensor.

12. The hydraulic or pneumatic valve of claim 9, wherein the displacement sensor comprises a LIDAR sender and receiver.

13. The hydraulic or pneumatic valve of claim 9, wherein the controller is further configured to:
determine that the calculated spring constant is less than the specified spring constant by a specified threshold; and
create a notification to replace the valve spring responsive to determining that the calculated spring constant is less than the specified spring constant by a specified threshold.

14. The hydraulic or pneumatic valve of claim 9, wherein the controller is further configured to:
determine that the calculated spring constant is greater than the specified spring constant by a specified threshold; and
create a notification to loosen the valve packing responsive to determining that the calculated spring constant is greater than the specified spring constant by a specified threshold.

15. A method comprising:
actuating a pneumatic or hydraulic valve, by an actuator, from a first position to a second position;
measuring a displacement of the valve between the first position and the second position;
measuring a pneumatic or hydraulic pressure of the valve actuator after actuating the pneumatic or hydraulic valve;
calculating a spring constant of the spring based on the measured displacement and the measured pressure;
comparing the calculated spring constant with a manufacturer listed spring constant;
determining that the calculated spring constant is less than the listed spring constant by a specified threshold; and
replacing the spring responsive to determining that the calculated spring constant is less than the listed spring constant by a specified threshold.

16. The method of claim 15, wherein the specified threshold is 10%.

17. The method of claim 15, wherein the first position is a fully closed position of the valve.

18. The method of claim 15, wherein the first position is a fully open position of the valve.

19. The method of claim 15, wherein the second position is a full stroke of the valve.

20. The method of claim 15, wherein the second position is a partial stroke of the valve.
